(19) United States
(12) Patent Application Publication
(10) Pub. No.: US 2006/0099458 A1
(43) Pub. Date: May 11, 2006

(54) 1, 4-Hydroquinone functionalized phosphinates and phosphonates

(76) Inventors: Mark V. Hanson, West Lafayette, IN (US); Larry D. Timberlake, West Lafayette, IN (US); Klemens Massone, Bad Durkheim (DE); Oliver Huttenloch, Ispringen (DE); Gunter Scherhag, Heidelberg (DE); Matthis Maase, Speyer (DE)

Correspondence Address: BAKER & DANIELS LLP, 300 NORTH MERIDIAN STREET, SUITE 2700, INDIANAPOLIS, IN, 46204, US

(21) Appl. No.: 11/232,390

(22) Filed: Sep. 21, 2005

Related U.S. Application Data
(63) Continuation-in-part of application No. 10/866,881, filed on Jun. 14, 2004.
Application No. 10/866,881 is a continuation-in-part of application No. 10/317,587, filed on Dec. 12, 2002, now Pat. No. 6,887,950.
Application No. 10/317,587 is a continuation-in-part of application No. 10/077,701, filed on Feb. 14, 2002, now Pat. No. 6,733,698.
(60) Provisional application No. 60/611,782, filed on Sep. 21, 2004.
(60) Provisional application No. 60/268,975, filed on Feb. 15, 2001.

(51) Int. Cl. B32B 9/04; C08G 65/28

(52) U.S. Cl. 428/704; 525/403

(57) ABSTRACT

There is presented novel 1,4-hydroquinone derivatized phosphinates and phosphonates. The novel compositions here presented are useful as polymer curing agents and as flame retardants.

This application is a continuation-in-part of patent application Ser. No. 10/866,881 filed Jun. 14, 2004, which is a continuation-in-part of U.S. patent application 10/317,587; a continuation-in-part of U.S. patent application Ser. No. 10/077,701, filed Feb. 14, 2002, now U.S. Pat. No. 6,733,698 based on provisional Patent application 60/368,075 filed Feb. 15, 2001, and provisional patent application 60/611,782 filed Sep. 21, 2004.

### SUMMARY OF THE INVENTION

This invention relates generally to the formulation and use of novel 1,4-hydroquinone and 1,4-naphthoquinone functionalized phosphinates and phosphonates useful as flame retarding components of epoxy resin systems. The phosphinates and phosphonates of the invention are useful as curing agents for epoxy resins with enhanced flame retardant properties. While the inventive phosphinates and phosphonates are useful alone to cure epoxy resins, greater utility may be found in combination with polyhydroxy compounds as co-curing agents. The 1,4-hydroquinone or 1,4-napthoquinonee functionalized phosphinates/novolac and phosphonates/novolac resin co-curing agents are suitable for flame retarding printed wiring boards. The invention is also useful as a co-curing agent in epoxy resin systems of prepregs, laminates, particularly copper-clad laminates useful in manufacturing electronic components free of halogen flame retardants.

### BACKGROUND OF THE INVENTION

Composite materials based on epoxy resins have received substantial acceptance in a variety of applications for a long time and continue to have considerable importance because of their versatility. A specific example of such an application includes but is not limited to electrical laminates used in printed circuit boards (printed wiring boards, PWB). The epoxy resins used therein have particularly gained popularity because of their ease of processibility. Those epoxy resins also feature good mechanical and chemical properties, such as for example, toughness and resistance to a variety of organic solvents and also display good chemical and moisture resistance. These properties permit the epoxy resin materials to be adapted to diverse application purposes and allow the materials sharing in the composite to be used advantageously.

Generally, the epoxy resins are readily processed into composite materials for PWB applications via the manufacturing of prepregs (B-staging). For example, the substrate material, which is typically an inorganic or organic reinforcing agent in the form of fibers, fleece and fabric or textile materials, is impregnated with the resin. This may be accomplished by coating the substrate with a resin solution in an easily vaporizable or volatilizable solvent. The coating may be carried out by a variety of well-known techniques including rolling, dipping, spraying, and combinations thereof. The prepregs are then heated in an oven chamber to remove solvent and to partially cure the resin. Advantageously, the prepregs obtained after this process will not self-adhere, but they also should not be fully cured. In addition, the prepregs should demonstrate storage stability. In the subsequent processing into composite materials, the prepregs should be fusable under conditions of applied heat and pressure so as to bind together with the reinforcing agents or insertion components as well as with the materials provided for the composite as compactly and permanently as possible; that is the cross-linked epoxy resin matrix must form a high degree of interfacial adherence with the reinforcing agents, as well as with the materials to be bonded together, such as metallic, ceramic, mineral and organic materials.

Flame resistance is a significant property for some applications involving polymeric materials. In some uses, flame resistance is given first priority, due to the danger to human beings and material assets, for example in structural materials for airplane and motor vehicle construction and for public transportation vehicles. In electronic applications, flame resistance is necessary because the components may generate substantial localized high temperatures on the laminate. Ignition of the laminate may cause the loss of the electronic components assembled thereon. Furthermore in the interest of human fire safety for devices containing PWB components, a high level of flame/fire protection is warranted.

Accordingly, it has been customary in the preparation of epoxy-containing laminates to incorporate into the epoxy resin compositions various additives and/or reactives to improve the flame retardancy of the resulting laminate. Many types of flame retardant substances have been used, however, the most common thus far used commercially have been halogen containing compounds such as tetrabromobisphenol A. This material is typically incorporated into an epoxy resin by reaction with the diglycidyl ether of bisphenol A. Typically, in order to reach the desired fire retardancy level (V-0 in the standard “Underwriters Laboratory” test method UL 94), levels of such bromine-containing flame retardant substances are required that provide a bromine content from 10 weight percent to 25 weight percent based on the total weight in the product.

Generally, halogen-containing fire retardant epoxy resins such as those containing tetrabromobisphenol A are considered to be safe and effective. However, there has been increasing interest by some to utilize flame-retarded epoxy systems that are not based on halogen chemistry. It is desirable for these new materials to be able to meet the requirements of fire retardancy and to display the same or greater advantages of mechanical properties, toughness, and solvent and moisture resistance that is offered with the halogenated materials currently used.

One such approach proposed by many researchers has been the use of phosphorus based fire retardants. See for example, EP 0 384 939; EP 0 384 940; EP 0 408 990; DE 4 308 185; DE 4 308 187; WO 96/07685; WO 96/07686; U.S. Pat. No. 5,648,171; U.S. Pat. No. 5,587,243; U.S. Pat. No. 5,576,357; U.S. Pat. No. 5,458,978; and U.S. Pat. No. 5,376,453; all of which are incorporated herein by reference in their entirety. In all of these references, a formulation is formed from the reaction of a flame retardant derived from a phosphorus compound and an epoxy resin, which is then cured with an amino cross-linker such as dicyandiamide, sulfanilamide, or some other nitrogen element containing cross-linker to form the thermosetting polymer network.

Specific examples of commercially available phosphorus-based fire retardant additives include Antiblaze™ 1045 (Albright and Wilson Ltd, United Kingdom) which is a phosphonic acid ester. Phosphoric acid esters have also been used as additives, such as, for example, PX-200 (Diahachi, Japan). Commercially available reactive phosphorus containing compounds that have been disclosed as being suitable for epoxy resins include Sanko HCA and Sanko HCA-HQ (Sanko Chemical Co., Ltd., Japan).

Alkyl and aryl substituted phosphonic acid esters have also been used to flame retard epoxy resins. More particularly, C₁-C₄ alkyl esters of phosphonic acid are of value because they contain a high proportion of phosphorus, and are thus able to impart fire retardant properties upon resins in which they are incorporated. However, the phosphonic acid esters have not been widely received as a substitute for halogenated flame retardants in epoxy resins for the production of electrical laminates because undesirable properties often result. For example, these phosphonic acid esters are known plasticizers and thus the laminates formed therefrom tend to exhibit undesirable low glass transition temperatures (T_{g}). An additional drawback is that the use of these phosphonic acid esters in amounts sufficient to provide the necessary flame retardancy increases the tendency of the resulting cured epoxy resin to absorb moisture. The moisture absorbency of the cured laminate board is very significant, because laminates containing high levels of moisture tend to blister and fail, when introduced to a bath of liquid solder at temperatures around 260° C., a typical step in the manufacture of printed wiring boards.

Other methods to impart flame retardancy involve preparation of halogen-free flame retardant epoxy resin compositions using a combination of resinous materials and an inorganic filler, such as aluminum trihydrate (EP 0 795 570 A1) or magnesium hydroxide (JP 2001213980 A2). These materials may, depending on the physical properties, render the processing of the epoxy resins more difficult, as they are insoluble in the resin systems. Additionally, fairly large load levels can be required, which can detract from the properties. See, generally, U.S. Pat. No. 6,097,100, WO 01/42359 and references cited therein for a description of various inorganic fillers.

Other efforts to provide non-halogen containing flame retardants directed to epoxy resin systems advantageously used for prepregs, laminates, copper clad laminates and printed wiring boards include hydroxyaryl phosphine oxide co-curing agents for epoxy resins. Such flame retarding co-curing agents are disclosed in U.S. Pat. No. 6,887,950.

It is an object of this invention to provide economical, useful 1,4-hydroquinone or 1,4-naphthoquinone functionalized phosphinates and functionalized phosphonates as flame retardant compositions for curing epoxy resins. Particular utility may be found in the applications of 1,4-hydroquinone or 1,4-naphthoquinone functionalized phosphinates and functionalized phosphonates of the invention to prepare hydrolytically and thermally stable, non-halogen containing epoxy resin systems for PWB materials.

It is a further object of this invention to provide halogen free 1,4-hydroquinone or 1,4-naphthoquinone functionalized phosphinates and functionalized phosphonates epoxy resin compositions that are useful as replacements for tetrabromobisphenol A in flame-retarded laminate applications.

These and other objects and advantages of the invention will be seen from the following detailed description.

The present invention is directed to formulations of phosphinates and phosphonates of structures (I) and (II) for flame retarding polymeric materials, specifically including printed wiring boards.

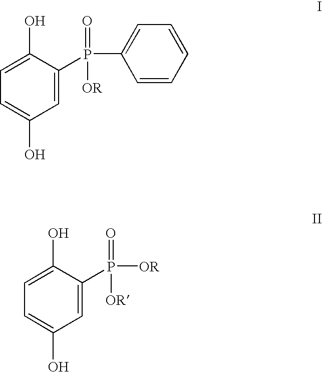

R, and R′ are defined below.

In addition to the hydroquinone based structures I and II above, applicants also disclose the instant invention to diol substituted napthalene compounds, to wit: 1,4-naphthoquinone functionalized phosphinates and phosphonates according to structures III and IV.

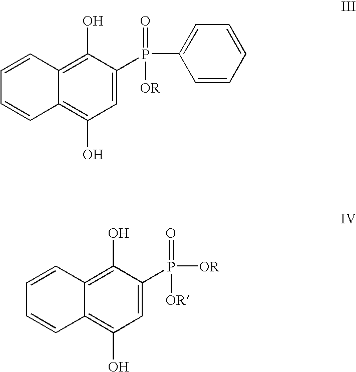

Unless the context requires otherwise, when reference is made hereafter to hydroquinones these napthalenediol compositions shall be understood as being also described.

More particularly, the present invention is directed to flame retarding epoxy resins used to prepare prepregs, laminates, and particularly copper clad laminates useful in manufacturing electronic components without the use of halogen-containing compounds. It is also directed to methods of flame retarding thermosetting resins and of manufacturing flame retarded printed wiring boards, prepregs, and laminates.

Curable, flame retardant epoxy resins suitable for use in the manufacture of resin formulations, prepregs, and laminates can be prepared from the advancement reaction of compounds of structures (I) and (II) with a halogen-free epoxy resin. The hydroxyl moiety of structures I II, III, and IV react readily with epoxide groups in standard epoxy resins. A wide range of molecular weights can be obtained in the copolymer product resins by use of the appropriate reaction stoichiometry. Suitable epoxy resins are, but not limited to, epoxy novolacs and bisphenol A diglycidyl ethers. The hydroquinones and naphthoquinones of the instant invention may also be used as hardeners for epoxy resins. These hardeners may be used themselves or in combination with another suitable hardener such as a phenolic novolac.

The compounds of Structures I and II may be functionalized at the phenolic reactive sites to produce epoxy intermediates of structures IA and IIA. For example, compounds of Structures I and II can be reacted with epichlorohydrin to give a difunctional epoxy compound. These compounds can then be used in like fashion as to commercial epoxy resins, that in namely, they may be used as epoxy resins, can be advanced or forwarded with difunctional hydroxy compounds, like Bisphenol A, or cured with a suitable hardener.

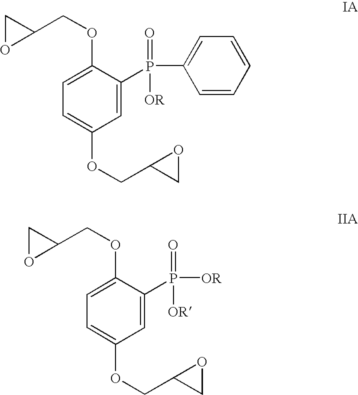

Structures III and IV form similar epoxy compounds upon reaction with epichlorohydrin.

The compositions of the instant invention are described as ‘non-halogen’ containing. It will be understood that addition of epichlorohydrin as a reactant may add trace amounts of chlorine, to form the epoxidized compounds of Structure (IA) and (IIA). Similarly, trace halogens may be present in the phosphinates and phosphonates of Structures I, II, III, and IV. Such halogens are insufficient to materially influence the flame retardancy. The presence of trace amounts of halogens as bi-products of the manufacture of precursors for the inventive compositions of the instant application is disregarded.

R, R′ each independently are the same or different aryl, aralkyl, alkenyl or alkyl comprising C₁-C₁₅. Aryl includes phenyl, biphenyl, napthyl and substituted analogs thereof selected from the group consisting of straight or branched alkoxy group such as methoxy, or ethoxy, straight or branched alkyl such as methyl, ethyl, propyl, butyl, pentyl, hexyl, heptyl, octyl, and nonyl, substituents. Alkenyl, group includes vinyl, propanyl, and butanyl, provided such substituent does not interfere with the ability of the phosphorus compound to react with a chosen polymer. For example, when R is phenylene, suitable substituted R are o-, m-, or p-hydroxy-methyl-phenyl, commonly known as o-cresyl, m-cresyl, or p-cresyl. Alkyl may be a straight, branched or cyclic saturated substituent, typically of 1-15 carbon atoms including methyl, ethyl, propyl, butyl, pentyl, hexyl, heptyl, octyl, nonyl, and decyl substituents. Aralkyl may be characterized by bonding an aromatic nucleus through one or more alkyl carbon atoms. Examples of aralkyl include phenylpropyl or phenylbutyl substituents.

A preferred embodiment is the use of compounds 1B: 2,5-dihydroxyphenyl-phenyl phosphinic acid 2,6-dimethyl-phenyl ester and 2B : 2,5-dihydroxyphenyl phosphonic acid bis(2,6-dimethylphenyl) ester. The presence of the 2,6-dimethylphenyl moiety provides for improved moisture resistance, thermal robustness, and good chemical stability.

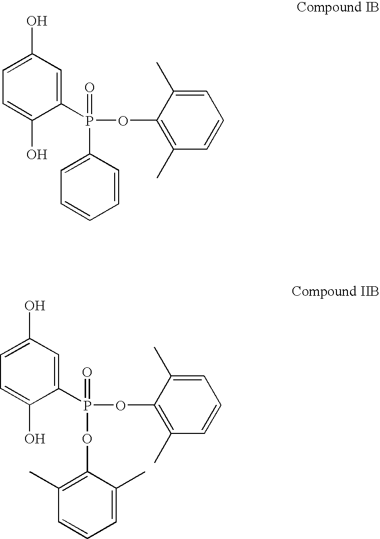

The compounds and formulations described above may be formulated with additional additives and fillers to affect cure rate, enhance flame retardancy, and increase physical properties. These compounds and formulations are intended to be used for the manufacture of prepregs and glass reinforced laminates for the fabrication of printed wiring boards.

Generally speaking, the 1,4-hydroquinone or 1,4-naphthoquinone functionalized phosphinate or phosphonate, or both comprises from about 25 to about 85 mole percent of the epoxy curing agent portion of an epoxy resin. Advantageously the hydroquinone or naphthoquinone portion provides fire/flame protection without adverse impact on the structural and electrical properties of a resulting electrical laminate. The hydroquinone or naphthoquinone portion may be as much as 90 or even 100 mole percent of the curing agent portion of an epoxy resin.

The polyhydroxy mixture also contains a phenolic co-crosslinking composition having a hydroxyl functionality of two or more and may include any suitable phenolic components, such as resins obtained from the reaction of phenols or alkylated phenols with formaldehyde, such as novolac resins, resole resins, dicylcopentadiene phenol novolac; or other hydroxy functional polymeric resins, containing the residue of hydroxystyrene, for example. Suitable polyfunctional phenolic monomeric and/or oligomeric compounds include tris(hydroxyphenyl) methane; tris(hydroxyphenyl) ethane; 1,3,5-trihydroxybenzene; tetraphenolethane; 3,4,5-trihydroxybenzoic acid (also known as gallic acid) or its derivatives, or pyrogallol (also known as 1,2,3-trihydroxybenzol); or 1,2,4-trihydroxybenzol (also known as hydroxyhydrochinon); 1,8,9 trihydroxyanthracene (also known as dithranol or 1,8,9-anthracentriol), or 1,2,10-trihydroxyanthracene (also known s anthrarobine); 2,4,5-trihydroxypyrimidine; and mixtures and reaction products of these compounds. Still further phenolic components may be found in U.S. Pat. No. 6,645,631, the disclosure of which is incorporated herein by reference. Monomeric, oligomeric and polymeric phenolic components may be blended if so desired to produce the phenolic co-crosslinking composition.

A preferred polyhydroxy co-crosslinking material is a novolac resin of the class including phenol formaldehyde resins, cresol formaldehyde resins and mixtures thereof. Perhaps the most preferred polyhydroxy novolac resins are those including the residues of a nitrogen heteroaryl compound, a phenol and an aldehyde, which resin may be selected from the group consisting of benzoguanamine phenol formaldehyde resins, acetoguanamine phenol formaldehyde resins, melamine phenol formaldehyde resins, benzoguanamine cresol formaldehyde resins, acetoguanamine cresol formaldehyde resins, melamine cresol formaldehyde resins, and mixtures thereof. Many other reaction products between phenolics, nitrogen-containing heteroaryl compounds, and an aldehyde would be recognized as forming suitable hydroxy-containing resins by one skilled in the art.

In yet other aspects, the invention includes a curable epoxy composition comprising:

an epoxy resin;

a co-crosslinking polyhydroxy mixture including:
1,4-hydroquinone or 1,4-naphthoquinone functionalized phosphinates and functionalized phosphonates, or both,
and the polyhydroxy mixture further includes a phenolic co-crosslinking composition including a phenolic component having a hydroxy funcionality of two or more as noted above.

The epoxy resin is in some embodiments a novolac epoxy resin while in other embodiments the epoxy resin may be based on epichlorohydrin and bisphenol A or in still yet other embodiments the epoxy resin is based on epichlorohydrin and bisphenol F. The curable epoxy compositions preferably have a phosphorous content of from about 0.2 wt. percent to about 5 wt. percent with from about 1 wt. percent to about 4 wt. percent being somewhat typical. From about 2 wt. percent to about 3 wt. percent is particularly preferred. Generally, the polyhydroxy mixture has a total hydroxy content of from about 50 mole % to about 150 mole % of the stoichiometric amount required to cure the epoxy resin present, with a hydroxy content of from about 75 mole % to about 125 mole % of the stoichiometric amount required to cure the epoxy resin being more preferred in many cases. Still more preferred may be a hydroxy content of from about 85 mole % to about 110 mole % of the stoichiometric amount required to cure the epoxy resin.

In many embodiments, from 1 mole % to about 99 mole % of the hydroxy moieties in the curing agent mixture are novolac resin hydroxyl groups whereas from about 15 mole % to about 75 mole % of the hydroxy moieties in the curing agent mixture being novolac resin hydroxyl groups is typical. Also, anywhere from about 1 mole % to about 99 mole % of the hydroxy moieties in the curing agent mixture are 1,4 hydroquinone or 1,4-naphthoquinone moieties, whereas from about 25 mole % to about 85 mole % of the hydroxy moieties in the curing agent mixture being 1,4-hydroquinone or 1,4-naphthoquinone moieties is typical.

In still yet another aspect of the invention, there is provided a resin-impregnated composite comprising a reinforcing component and the flame retardant epoxy composition described herein, at least partially cured. The composite includes a glass filler, a glass fiber or a glass fabric and optionally includes a copper foil layer adhered to the resin-impregnated composite. Such laminates generally include a plurality of layers of resin-impregnated glass fabric, press-formed into a substantially integrated structure generally inseparable into its constituent layers. Although glass is often the reinforcement of choice, composites including carbon fiber, polyaramid fiber, and quartz are also contemplated within the scope of the invention.

This invention pertains to the use of 1,4-hydroquinone or naphthoquinone functionalized phosphinates and phosphonates described herein blended with a polyhydroxy co-curing agent in epoxy resin formulations. A typical curable formulation is comprised of, but not limited to A) a 1,4-hydroquinone or 1,4-naphthoquinone functionalized phosphinates and functionalized phosphonates, or both or the present invention, B) a novolac resin, C) an epoxy resin or epoxy resin combination, D) a filler or filler combination, E) curing accelerator, F) and a suitable solvent or solvent combinations. This formulation may also contain additives or reactives chosen by one skilled in the art to effect certain desired properties.

A preferred embodiment of this invention is the use of a 1,4-hydroquinone or 1,4-naphthoquinone functionalized phosphinates and functionalized phosphonates, or both as a blend with polyhydroxy novolac resins. The 1,4-hydroquinone or 1,4-naphthoquinone functionalized phosphinates and functionalized phosphonates described herein are easily dissolved as a mixture with a wide variety of novolac resins with the use of a suitable solvent. These resin solutions provide a resin curing solution that imparts excellent handling and ease of use. These resin curing solutions are stable and inhibit crystallization of either the 1,4-hydroquinone or 1,4-naphthoquinone functionalized phosphinates and functionalized phosphonates or the selected novolac. Alternatively, the blend may be formed in selected cases by melt blending the a 1,4-hydroquinone or 1,4-naphthoquinone functionalized phosphinates and functionalized phosphonates, or both with a suitable novolac. If the novolac resin is a solid, the a 1,4-hydroquinone or 1,4-naphthoquinone functionalized phosphinates and functionalized phosphonates, or both/novolac resin mixture may be processed as a solid blend and used in the solid form. An optional embodiment is the addition of the a 1,4-hydroquinone or 1,4-naphthoquinone functionalized phosphinates and functionalized phosphonates, or both and the novolac resin individually into the curable resin formulation.

Unless otherwise indicated, or it is clear from the context, the terminology phenolic novolac resin and the like means and includes hydroxyl-functional resinous compositions including the condensation products of one or more substituted or unsubstituted phenolic compounds and one or more aldehydes, preferably formaldehyde. Such resins may optionally include heteroaryl components such as melamine and guanamines as noted hereinafter.

The curable, flame retardant epoxy resin compositions suitable for use in the manufacture of prepregs, and laminates can be prepared from the formulation of 1,4-hydroquinone or 1,4-naphthoquinone functionalized phosphinate, 1,4-hydroquinone or 1,4-naphthoquinone functionalized phosphonate, or both, with novolac resins and a commercially available epoxy resin. The product distribution of the 1,4-hydroquinone or 1,4-naphthoquinone functionalized phosphinate, 1,4-hydroquinone or 1,4-naphthoquinone functionalized phosphonate, or both, enables certain physical characteristics to be easily affected in the cured and uncured resin. The properties involved are, for example, but not limited to, molecular weight, viscosity, glass transition temperature, and gel point. The reasons for this are related to the type and source of aromatic hydroxyl groups present in the curing agent mixture.

The epoxy resin can be crosslinked with 1,4-hydroquinone or 1,4-naphthoquinone functionalized phosphinate, 1,4-hydroquinone functionalized or 1,4-naphthoquinone phosphonate, or both, along with a phenolic co-crosslinking composition. The phenolic co-crosslinking composition comprises novolac resins, such as phenol-formaldehyde resins, cresol-formaldehyde resins, and mixtures thereof. A polymer of a phenol, nitrogen heteroaryl compound and aldehyde is also suitable. Examples include benzoguanamine-phenol-formaldehyde resins, acetoguanamine-phenol-formaldehyde resins, melamine-phenol-formaldehyde resins, benzoguanamine-cresol-formaldehyde resins, acetoguanamine-cresol-formaldehyde resins, melamine-cresol-formaldehyde resins, and mixtures thereof.

The co-curing composition also includes a phenolic material with a hydroxy functionality of two or more. Typical phenolic compounds are:

a) resins obtained from the reaction of phenols or alkylated phenols with formaldehyde, such as novolac resins or resole resins.

b) Polyhydroxy aromatic materials such as: tris(hydroxyphenyl)methane; tris(hydroxyphenyl)ethane; 1,3,5-trihydroxybenzene; tetraphenolethane, and so forth as noted above.

The preferred phenolic co-curing component is a novolac resin of the class including phenol formaldehyde resins, cresol formaldehyde resins and mixtures thereof. Preferred polyhydroxy novolac resins include the residue of a nitrogen heteroaryl compound, a phenol and an aldehyde, which may be selected from the group consisting of benzoguanamine phenol formaldehyde, acetoguanamine phenol formaldehyde, melamine phenol formaldehyde, benzoguanamine cresol formaldehyde, acetoguanamine cresol formaldehyde, melamine cresol formaldehyde, and mixtures thereof. Many other reaction products between phenolics, nitrogen-containing heteroaryl compounds, and an aldehyde would be recognized as forming suitable hydroxy-containing resins by one skilled in the art.

Polyhydroxy novolac resins that contain phenol/aldehyde copolymers such as copolymers containing the residue of formaldehyde and one or more of phenol or a substituted phenol such as cresol or bisphenol A, or various other hydroxy-substituted benzenes, are particularly preferred in some embodiments. This component is used as a co-hardener with the stated 1,4-hydroquinone or 1,4-naphthoquinone functionalized phosphinates and functionalized phosphonates of this invention. Phenol novolac resins are readily available commercial materials and are typically characterized by general chemical structure V:

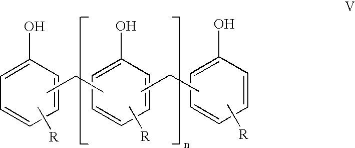

where R may represent hydrogen, an alkyl group such as methyl and so forth.

Suitable novolac resins include, for example, but are not limited to: Durite® SD-1708, SL-1710, SD-1502, SD-1702, SD-1731, SD-1734, SD-241A, SD-423A, RD-2414, SD-5132, SD-7280, SD-1502, SD-500C, available from the Hexion Specialty Chemicals, Inc. GP-2074, 5300, 5833, 834D54, available from Georgia Pacific; HRJ-11040, 1166, 1583, 2210, 2355, 2901, CRJ-406, and FRJ-425/200, available from Schenectady International.

Polyhydroxy novolac resins that include a copolymer comprising a reaction product of a nitrogen heteroaryl compound, a phenol and an aldehyde are particularly preferred in some cases. As previously noted, these resins may be selected from the group consisting of benzoguanamine phenol formaldehyde, acetoguanamine phenol formaldehyde, melamine phenol formaldehyde, benzoguanamine cresol formaldehyde, acetoguanamine cresol formaldehyde, melamine cresol formaldehyde, and mixtures thereof. Many other reaction products between phenolics, nitrogen-containing heteroaryl compounds, and an aldehyde would be recognized as forming suitable hydroxy-containing resins by one skilled in the art. If so desired, other aldehydes and/or other triazine compounds may be used. These resins are prepared as disclosed in Encyclopedia of Polymer Science and Engineering, 2^{nd} ed., Vol 11, p 50; or in Kirk-Othmer Encyclopedia of Chemical Technology, 4^{th} ed. Vol 18, p 606.

Representative epoxy resins suitable for use in the present invention are presented in Epoxy Resins Chemistry and Technology Second Edition edited by Clayton A. May (Marcel Dekker, Inc. New York, 1988), Chemistry and Technology of Epoxy Resins edited by B. Ellis (Blackie Academic & Professional, Glasgow, 1993), Handbook of Epoxy Resins by H. E. Lee and K. Neville (McGraw Hill, New York, 1967), and EP 1116774 A2. Suitable epoxy resins are, but not limited to, epoxy resins based on bisphenols and polyphenols, such as, bisphenol A, tetramethylbisphenol A, bisphenol F, bisphenol S, tetrakisphenylolethane, resorcinol, 4,4′-biphenyl, dihydroxynaphthylene, and epoxy resins derived from novolacs, such as, phenol:formaldehyde novolac, cresol:formaldehyde novolac, bisphenol A novolac, biphenyl-, toluene-, xylene, or mesitylene-modified phenol:formaldehyde novolac, aminotriazine novolac resins and heterocyclic epoxy resins derived from p-amino phenol and cyanuric acid. Additionally, aliphatic epoxy resins derived from 1,4-butanediol, glycerol, and dicyclopentadiene skeletons, are suitable, for example. Many other suitable epoxy resin systems are available and would also be recognized as being suitable by one skilled in the art.

It is generally advantageous to use an epoxy resin which possesses on average more than 1 and preferably at least 1.8, more preferably at least 2 epoxy groups per molecule. In the most preferred case the epoxy resin is a novolac epoxy resin with at least 2.5 epoxy groups per molecule. In the broadest aspect of the invention, the epoxy resin may be any saturated or unsaturated aliphatic, cycloaliphatic, aromatic or heterocyclic compound which possesses more than one 1,2-epoxy group. Examples of heterocyclic epoxy compounds are diglycidylhydantoin or triglycidyl isocyanurate (TGIC).

The epoxy resin is preferably one that has no lower alkyl aliphatic substituents, for example the glycidyl ether of a phenol novolac, or the glycidyl ether of bisphenol-F. Preferred epoxy resins are epoxy novolac resins (sometimes referred to as epoxidized phenolic novolac resins, a term which is intended to embrace both epoxy phenol novolac resins and epoxy cresol novolac resins).

Epoxy novolac resins (including epoxy cresol novolac resins) are readily commercially available, for example, under the trade names D.E.N.™, Quatrex™, (Trademarks of the Dow Chemical Company), and Epon™ (trademark of Hexion Specialty Chemicals, Inc.).

The 1,4-hydroquinone or 1,4-naphthoquinone functionalized phosphinates and functionalized phosphonates, or both can optionally be applied for use as flame retardants for a vast array of thermosetting and thermoplastic resins, such as polycarbonates, polyesters, vinyl esters, cyanate esters, polyamides, polyimides, polyolefins including polyethylenes, polypropylenes, poly-4-methyl pentene, polystyrene, co-polymers of acrylonitrile-styrene-butadiene, polyurethanes, and many others; but more specifically, to the flame retardation of epoxy resins as a general approach.

The 1,4-hydroquinone or 1,4-naphthoquinone functionalized phosphinates and functionalized phosphonates, or both may be converted to any number of functional groups by those skilled in the art, such as, but not limited to, ethers, carbonates, carbamates, and esters to modify the properties of the materials to improve the compatibility in a given resin system. In particular, these materials may be used directly as a cross-linking agent in epoxy resin formulations. These materials are intended for flame retardant printed wiring boards. In addition, the resins described in the present invention may be formulated with additional additives and fillers to affect cure rate, enhance flame retardancy, and increase physical properties.

Additionally, the compositions of the present invention may be formulated with other flame-retardant materials as co-additives with the compositions of the present invention to improve the performance. These co-FR materials could be either inorganic or organic and can be reactive or additive based compounds. Examples of inorganic additive type materials include, but not limited to, alumina trihydrate (ATH), magnesium hydroxide, barium hydroxide, calcium carbonate, titanium dioxide, and silicon dioxide. A particularly useful co-FR filler material is ATH. The self-extinguishing nature of the co-curing agent of the present invention may be further enhanced to meet the UL-94 V-0 requirement by the addition of suitable flame retardant adjuvants. Other filler materials described above would be recognized as being beneficial to the flame-retardant properties by one skilled in the art. Examples of organic based additives or reactives include, but are not limited to, triphenyl phosphate, resorcinol bis(di-2,6-xylyl phosphate), 9,10-dihydro-9-oxa-10-phosphaphenanthrene-10-oxide, bisphenol A bis(diphenyl-phosphate), melamine, melamine phosphate, melamine borate and many others familiar to one skilled in the art.

Fillers may be used in the invention to affect physical properties and to reduce costs. Typically, fillers and reinforcing agents include mica, talc, kaolin, bentonite, wollastonite, glass fiber, glass fabrics glass matt, milled glass fiber, glass beads (solid or hollow), silica, or silicon carbide whiskers and so forth. Many of these materials are enumerated in the Encyclopedia of Materials Science and Engineering, Vol. # 3, pp. 1745-1759, MIT Press, Cambridge, Mass. (1986), the disclosure of which is incorporated herein by reference. Combinations of fillers are preferred in some embodiments; whereas in other embodiments, the reinforcing agent makes up most of the composite of the invention, as in the case of glass fabric used in prepregs and laminates for printed wiring boards.

Suitable curing accelerators or catalysts that can be used in the formulation include, but are not limited to, substituted or unsubstituted imidazoles such as imidazole, 2-methylimidazole, 2-ethyl-4-methylimidazole, 2-phenylimidazole, etc. Other catalysts include tertiary amines and amides. Phosphine catalyst can also be used, such as triphenylphosphine. Lewis acids may also be used alone or in combination with other catalysts, which is a common practice to one skilled in the art. Typical examples of Lewis acids include oxides and hydroxides of zinc, tin, silicon, aluminum, boron, and iron; borontrifluoride or boric acid can also be used.

In accordance with the practice of this invention a resin-impregnated composite comprising at least one of a filler or reinforcing agent and the curable composition as described herein is provided, which is at least partially cured. For example, the 1,4-hydroquinone or 1,4-naphthoquinone functionalized phosphinates and functionalized phosphonates mixtures, polyhydroxy resins and epoxy resins of the invention are advantageously used in the fabrication of prepregs and laminates used to make printed wiring boards. The resin prepared as described herein is mixed with one or more hardener(s) and optionally accelerator(s) and applied to a glass cloth. The resin-impregnated sheets or prepregs are then at least partially cured in an oven typically at 150° C.-200° C. for a few minutes; for example, from 1-5 minutes.

In order to prepare a laminate of the class used for printed wiring boards, a plurality of prepregs are stacked next to each other, wherein resin-impregnated layers are shown. On each side of the stack there is provided a copper foil layer, such as layers. The stack, including cloth layers and foil layers is then pressed at a pressure of 20 to 50 psi, preferably 30-35 psi at elevated temperatures of from 170 to 220° C. in a press for an hour or more to produce a consolidated laminate. Laminate thus includes a plurality of fused layers of the resin-impregnated glass fabric. If so desired, more or fewer layers of prepregs or foil may be used depending on the desired structure.

In the Examples that follow, the following abbreviations are used:

ATH alumina trihydrate

DEN 438 epoxidized novolac resin available from the Dow Chemical Co.
Dowanol PM 1-methoxy-2-propanol
DSC differential scanning calorimetry
FR flame retardant
2MI 2-methylimidazole
³¹P NMR nuclear magnetic resonance spectroscopy of phosphorus
PWB printed wiring boards
phr parts per hundred resin
T_{g} glass transition temperature
SD-1708 phenol-formaldehyde resin (novolac resin) available from Hexion Specialty Chemicals, Inc.
TGA thermal gravimetric analysis

### EXAMPLES

### Example 1

Preparation of 2,5-dihydroxyphenyl-phenyl phosphinic acid 2,6-dimethyl-phenyl ester (Compound IB).

390 g (3.2 mol) 2,6-Dimethylphenol is added into the reaction vessel and heated to 60° C. yielding a melt. Subsequently, 572 g (3.2 mol) phenyldichlorophosphine is added while stirring. After two hours the temperature is raised to 95° C., then to 135° C. for two hours, and to 185° C. for two hours to remove HCl-gas. The mixture is cooled to ambient temberature and 2.1 liter of toluene is added. Within 0.5 hours a stoichiometric amount of water is added. From ambient temperature the reaction mixture is observed to increase to a maximum of 45° C. and return to ambient with stirring over 4 hours. 1.8 g (0.03 mol) of acetic acid are added as catalyst. The mixture is heated to 80-85° C. and 3.4 mol of 1,4-benzoquinone (solution in 4.7 liter of toluene) is continuously added over 6 hr. After completion of the addition, the mixture is stirred at 95° C. for 20 hours. The crude product is purified by crystallization. The material has a melting point of 172° C. and is soluble in acetone. The product was identified by ³¹P NMR spectroscopy and elemental analysis.

### Example 2

Preparation of 2,5-dihydroxyphenyl phosphonic acid bis(2,6-dimethylphenyl) ester (Compound IIB).

100.0 g of 2,6-dimethylphenol may be added into a reaction vessel and heated to 60° C. yielding a melt. Subsequently, 56.2 g of phosphorus trichloride may be added by drop while stirring. After 2 hours the temperature may be sequentially raised to 95° C., for 2 h; 135° C. for 2 hours; and to 185° C. for 2 hours to remove HCl. The mixture may be cooled to ambient temperature and 200 g of toluene may be added. Within 0.5 hours, 7.38 g of water may be added, and may be stirred without heating for 4 hours. 400 g of toluene may be added. 0.22 g of acetic acid may be added as catalyst. The mixture may be heated to 80-90° C. and 44.2 g of 1,4-benzoquinone may be added over 6 hours. The reaction mixture may be heated at 110° C. for an additional 10-20 h. The crude product may be purified by crystallization or column chromatography. The product may be identified by ³¹P NMR spectroscopy and elemental analysis.

### Example 3

Preparation of Laminate Using Compound 1 as Co-Curing Agent.

Prepare a solution of 64.5 phr 2,5-dihydroxyphenyl-phenyl phosphinic acid 2,6-dimethyl-phenyl ester prepared by Example 1 and 17.7 phr SD-1708 in 127 phr Dowanol PM. Add 100 phr DEN 438 epoxy resin and 0.0013 phr of 2-methylimidazole to the solution. The resulting varnish impregnates eight 12×12″ plies of glas fabric and is then B-staged in an oven at 170° C. for approximately 2 minutes to form prepregs. Eight 11×11″ prepregs are stacked with 2 outer 12×12″ sheets of 1 oz. copper foil and pressed at 185° C., 33 PSI, for 160 minutes to give a laminate board.

### Example 4

Preparation of Laminate Using 2,5-dihydroxyphenyl-phenyl phosphinic acid 2,6-dimethyl-phenyl ester as Co-Curing Agent with ATH as Co-FR Material.

Prepare a solution of 64.6 phr 2,5-dihydroxyphenyl-phenyl phosphinic acid 2,6-dimethyl-phenyl ester prepared by Example 1 and 17.7 phr SD-1708 in 127 phr Dowanol PM. 100 phr DEN 438, 78.2 phr ATH, and 0.0010 phr 2-methylimidazole are added to the solution to form a slurry. Use the resulting varnish to impregnate eight 12×12″ plies of 7628 glass fabric and B-stage at 170° C. Eight 11×11″ prepregs are stacked with 2 outer 12×12″ sheets of 1 oz. copper foil and pressed at 185° C., 33 PSI for 160 minutes to give a laminate board.

### Example 5

Description of Laminate Using 2,5-Dihydroxyphenyl phosphonic acid bis(2,6-dimethylphenyl) ester as co-curing Agent.

72.5 phr of 2,5-Dihydroxyphenyl phosphonic acid bis(2,6-dimethylphenyl) ester by Example 2 and 17.7 phr SD 1708 may be stirred with 127 phr of Dowanol PM. 100 phr DEN 438, and 0.0013 phr 2-methylimidazole may then added. The resulting varnish may impregnate eight 12×12″ plies of 7628 glass fabric, and may be B-stage at 170° C. Eight 11×11″ prepregs may be stacked with 2 outer 12×12″ sheets of 1 oz. copper foil, and may be pressed at 185° C., 33 PSI, for 160 min. to give a laminate board.

### Example 6

Laminate Prepared from novolac Hardener.

A laminate is prepared according to the procedure of Example 3 using novolac resin according to structure V as the only hardener for the epoxy resin.

Performance characteristics of the material prepared by the Examples is provided in Table 1

TABLE 1

| | Formulation No. (phr) | | |
|---|---|---|---|
| | 4 | 3 | 6 |
| Composition/Example | | | |
| DEN 438 | 100 | 100 | 100 |
| Structure 1B | 64.6 | 64.5 | none |
| 2,5-dihydroxyphenyl-phenyl | | | |
| phosphinic acid 2,6-dimethyl- | | | |
| phenyl ester | | | |
| SD-1708 | 17.7 | 17.7 | 72.6 |
| 2-MI | 0.001 | 0.001 | 0.05 |
| ATH | 78.2 | none | none |
| Laminate Properties | | | |
| TGA,¹ 5% ° C. | 344 | 376 | 387 |
| Tg ° C. (by DSC) | 116 | 133 | 174 |
| T-260,² minutes | no failure | no failure | N/A |
| T-288,² minutes | >90 | 46 | N/A |
| Pressure cooker/solder dip (% | 0.218/5 | 0.219/5 | N/A/5 |
| moisture/Rating; 5 = best) | | | |
| UL-94 Burn Test Ave T1/T2 | 18/13 | 44/0 | 67/0 |
| Total Burn Time³, sec. | 155 | 219 | 335 |
| Burn Observations | weak flame, | weak flame, | Total |
| | slow burn 1 | slow burn 2 | consumption |
| | inch | inches | of |
| | (2.5 cm) | (5 cm) up | laminate |
| | up edge, | edge, self- | |
| | self- | extinguish | |
| | extinguish | | |

Footnotes:
¹TGA Experimental: A sample is analyzed in a thermogravimetric analyzer. The temperature in the analyzer is increased at the rate of 10° C./min. from room temperature to a maximum of 700° C. in a nitrogen atmosphere. The temperature reported is the temperature at which a 5% mass loss occurs.
²T-260 refers to a test method defined by the IPC (Association Connecting Electronics Industries) to determine the time to delamination at 260° C. using a Thermomechanical analyzer (TMA). Test method No. 2.4.24.1 is used. T-288 is likewise conducted to determine the time to delamination, but at the temperature of 288° C.
³The total burn time of five test coupons, each coupon having two flame applications.

The data in Table 1 indicate that the formulations containing 2,5-dihydroxyphenyl-phenyl phosphinic acid 2,6-dimethyl-phenyl ester shows inherent flame retardant properties. Although these formulations were not optimized for V-0 FR performance, the inherent FR properties are apparent from the very weak flame front and self-extinguishing behavior. By contrast, the non-FR control sample had a much more intense flame front that resulted in total consumption of the laminate sample.

These base formulations that use the material show very good thermal stability, as represented by the relatively high TGA 5% wt loss values being close to the non-flame-retarded control sample, as well as the T-260 and T-288 results being far beyond what would be required for lead-free solder applications.

What is claimed is:

1. A composition comprising a 1,4-hydroquinone derivatized phosphinate, a 1,4-hydroquinone derivatized phosphonate; a 1,4-naphthoquinone derivatized phosphinate, a 1,4-naphthoquinone derivatized phosphonate, or a combination thereof according to structures I, II, III, IV below 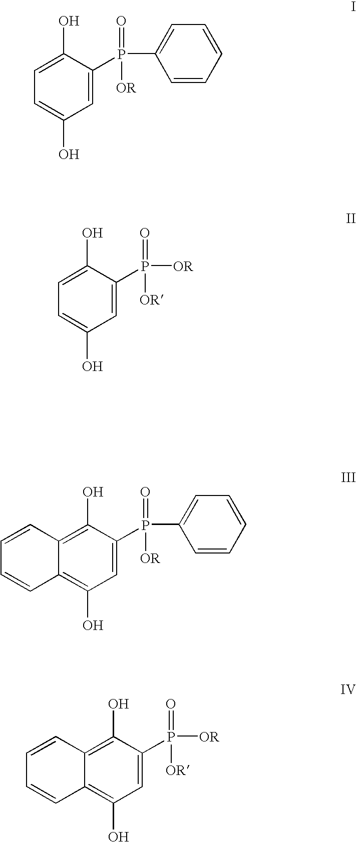
where R, R′ each independently are the same or different aryl, aralkyl or alkyl comprising from one to 15 carbon atoms, except for structure I, R may not be methyl or ethyl, and for structure II, R and R′ may not both be methyl, ethyl, or isopropyl.

2. The composition of claim 1 where structure I is 2,5-dihydroxyphenyl-phenyl phosphinic acid 2,6-dimethyl-phenyl ester.

3. The composition of claim 1 where structure II is 2,5-dihydroxyphenyl phosphonic acid bis(2,6-dimethylphenyl) ester.

4. A polymer composition comprising one or more of the structures of claim 1.

5. The polymer composition of claim 4 wherein the polymer is a thermoset resin.

6. The polymer composition of claim 4, wherein the polymer is a thermoplastic resin.

7. The composition of claim 5 wherein the polymer is an epoxy resin.

8. The composition of claim 7 wherein the epoxy resin is also reacted with a novolac

9. The composition of claim 8 also comprising a reinforcing material.

10. The composition of claim 9 wherein the reinforcement is a fiber of glass, carbon, polyaramid, or quartz.

11. The composition of claim 9 where the resin and reinforcement are partially cured to form a prepreg.

12. A consolidated laminate formed from a plurality of prepregs according to claim 11.

13. A laminate according to claim 12 also comprising copper foil.

14. The composition of claim 7 wherein the structure is selected from 2,5-dihydroxyphenyl-phenyl phosphinic acid 2,6-dimethyl-phenyl ester, 2,5-dihydroxyphenyl phosphonic acid bis(2,6-dimethylphenyl) ester; 2,5-dihydroxynaphthyl-phenyl phosphinic acid 2,6-dimethyl-phenyl ester; 2,5-dihydroxynaphthyl-phosphonic acid bis(2,6-dimethylphenyl) ester, or a combination thereof.

15. The resin of claim 13 wherein the 1,4-hydroquinone derivatized phosphonate, is selected from 2,5-dihydroxyphenyl-phenyl phosphonic acid 2,6-dimethyl-phenyl ester, or 2,5-dihydroxyphenyl phosphonic acid bis(2,6-dimethylphenyl) ester, 2,5-dihydroxynaphthyl-phenyl phosphinic acid 2,6-dimethyl-phenyl ester; 2,5-dihydroxynaphthyl-phosphonic acid bis(2,6-dimethylphenyl) ester, or a combination thereof.

16. An epoxy resin comprising the reaction product of 1,4-hydroquinone derivatized phosphinate, a 1,4-hydroquinone derivatized phosphonate; a 1,4-naphthoquinone derivatized phosphinate, a 1,4-naphthoquinone derivatized phosphonate, or a combination thereof according to structures I, II, III, IV below 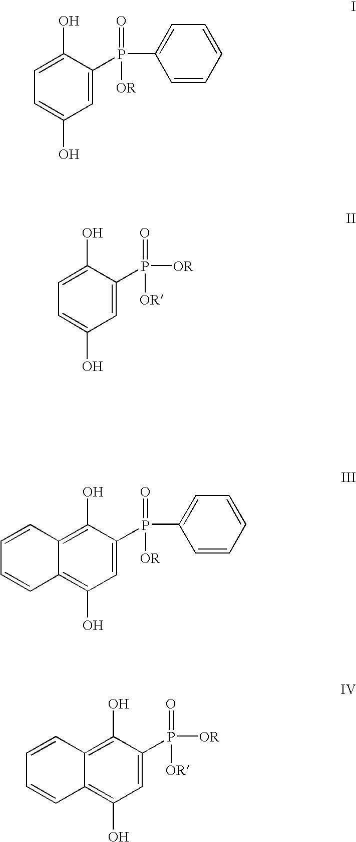
where R, R′ each independently are the same or different aryl, aralkyl or alkyl comprising from one to 15 carbon atoms and epichlorohydrin.

17. An epoxy resin comprising the reaction product of 1,4-hydroquinone derivatized phosphinate, a 1,4-hydroquinone derivatized phosphonate; a 2,5-naphthalenediol derivatized phosphinate, a 2,5-napthalenediol derivatized phosphonate, or a combination thereof and epichlorohydrin.

18. The composition of claim 1 where structure III is 2,5-dihydroxynaphthyl-phenyl phosphinic acid 2,6-dimethyl-phenyl ester.

19. The composition of claim 1 where structure IV is 2,5-dihydroxynaphthyl-phosphonic acid bis(2,6-dimethylphenyl) ester.

20. A composition comprising a 1,4-hydroquinone derivatized phosphinate, a 1,4-hydroquinone derivatized phosphonate; a 1,4-naphthoquinone derivatized phosphinate, a 1,4-naphthoquinone derivatized phosphonate, or a combination thereof according to structures I, II, III, IV below 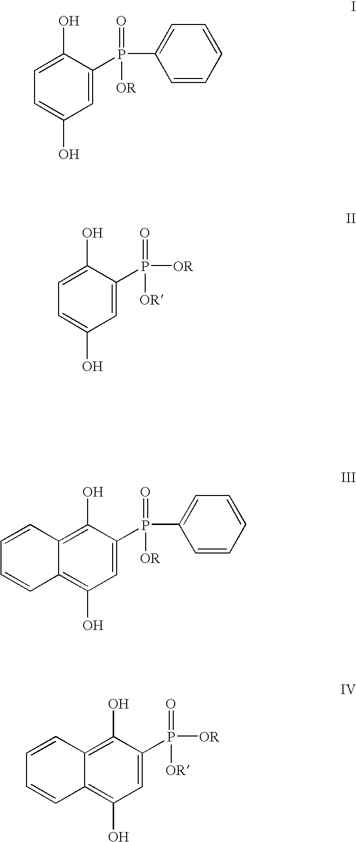
where R, R′ each independently are the same or different aryl, aralkyl or alkyl comprising from one to 15 carbon atoms and a polymer.
